(19) United States
(12) Patent Application Publication
(10) Pub. No.: US 2002/0008498 A1
(43) Pub. Date: Jan. 24, 2002

(54) Charge circuit

(75) Inventor: Ivan Tong, Shindian City (TW)

Correspondence Address: Leonard Bloom & Associates, LLC, Intellectual property law offices, Suite 905, 401 Washington Avenue, Towson, MD, 21204, US

(73) Assignee: Twinhead International Corporation

(21) Appl. No.: 09/731,603

(22) Filed: Dec. 7, 2000

(30) Foreign Application Priority Data
Jul. 18, 2000 (TW) 89212778

(51) Int. Cl. H02J 7/16

(52) U.S. Cl. 320/141

(57) ABSTRACT

A charge circuit adapted to be used in an information system for charging a battery mounted in the information system, the information system being electrically coupled to a power source. The charge circuit includes a pulse width modulation controller electrically coupled to the battery for controlling a charge current to be delivered to the battery, and a system current detecting feedback circuit electrically coupled to the power source and to the pulse width modulation controller for outputting a control signal to the pulse width modulation controller in response to the comparison between a current outputted from the power source and a threshold value. The present invention also a charging method for an information system.

### FIELD OF THE INVENTION

The present invention relates to a charge circuit and charging method, and more particularly to a charge circuit and charging method used in an information system.

### BACKGROUND OF THE INVENTION

The rechargeable battery, which is one of main power supplies in the portable computer, provides a convenient power source under the condition without AC power. For users' convenience, a charge circuit is usually mounted within the portable computer. The rechargeable battery, for example but not limited to a nickel-hydrogen battery, a lithium ion battery and a nickel-cadmium battery is charged through the charge circuit mounted within the portable computer. Please refer to FIG. 1, the process for charging the traditional rechargeable battery mainly includes two steps. Step 1 is to process the constant current charge mode by using a constant current feedback circuit, and Step 2 is to process the constant voltage charge mode by using a constant voltage feedback circuit. Meanwhile, Step 1 is to charge the rechargeable battery with a constant current, and the charge current is decreased gradually when up to Step 2. Because the rated current outputted from the adapter electrically connected to the portable computer is limited to a maximum value, the conventional charge circuit is usually set “disable” to stop charging the battery when the operating system of the portable computer starts to operate. Such “disable” action can avoid the sum of the operating current and the charge current in the portable computer exceeding the rated current provided from the adapter.

Additionally, the conventional charge circuit stops charging the rechargeable battery immediately after the operating system of the portable computer starts to operate, which results in an ineffective charging. For example, the adapter can provide a certain power, such as 150-Watt; however, the power consumed by the portable computer changes with time. Under the optimum condition, the remaining power after subtracting the power consumed by the portable computer is used to charge the rechargeable battery. If the operation of the portable computer depletes 90-Watt power, only 60-Watt remaining power can be adapted to charge the rechargeable battery. Therefore, it is important to overcome the above-mentioned defects and to provide a lower manufacturing cost and high-efficiency charge circuit.

It is therefore tried by the applicant to deal with the above situation encountered by the prior art.

### SUMMARY OF THE INVENTION

It is therefore an object of the present invention to provide a charge circuit having less manufacturing cost and high efficient charging ability for the rechargeable battery in the information system.

It is another object of the present invention to provide an architecture for a charge circuit to efficiently utilize the power to apply the surplus power from the information system to charge the rechargeable battery all the time

It is another object of the present invention to provide an architecture for a charge circuit to regulate the magnitude of the charge current in response to the magnitude of system load.

According to the present invention, a charge circuit adapted to be used in a portable computer for charging a rechargeable battery mounted in the portable computer, the portable computer being electrically connected to an adapter and power-supplied by the adapter. The charge circuit includes a pulse width modulation controller electrically connected to the rechargeable battery for controlling a charge current to be delivered to the rechargeable battery, and a system current detecting feedback circuit electrically connected between the adapter and the pulse width modulation controller for outputting a control signal to the pulse width modulation controller in response to the comparison between a total current outputted from the adapter and a threshold value, thereby controlling the charge current outputted from the pulse width modulation controller. When the current outputted from the adapter is smaller than the threshold value, the charge current outputted from the pulse width modulation controller increases in response to the total current outputted from the adapter.

Generally, the charge circuit further includes a current feedback circuit electrically connected to the pulse width modulation controller for outputting a current feedback signal to the pulse width modulation controller in response to the magnitude of the charge current outputted from the pulse width modulation controller, thereby steadying the charge current outputted from the pulse width modulation controller, and a voltage feedback circuit electrically connected to the pulse width modulation controller for outputting a voltage feedback signal to the pulse width modulation controller in response to the magnitude of a charge voltage outputted from the pulse width modulation controller, thereby steadying the charge voltage outputted from the pulse width modulation controller.

Certainly, the charge circuit can further include three diodes electrically connected between the system current detecting feedback circuit and the pulse width modulation controller, the current feedback circuit and the pulse width modulation controller, the voltage feedback circuit and the pulse width modulation controller, respectively, thereby enabling to output a largest voltage among the control signal, the current feedback signal and the voltage feedback signal to be delivered to the pulse width modulation controller.

Preferably, the system current detecting feedback circuit includes a detecting resistor electrically connected to the adapter and the charge circuit for generating a sense voltage in response to the total current outputted from the adapter, a voltage amplifier electrically connected to the detecting resistor for amplifying the sense voltage to be a comparing voltage, a threshold voltage generator for generating a threshold voltage, an operating amplifier electrically connected to the voltage amplifier and the threshold voltage generator for outputting a comparing signal in response to the comparison between the comparing voltage and the threshold voltage, and a control switch electrically connected to an output of the operating amplifier and the pulse width modulation controller for allowing the control signal to be fed back to the pulse width modulation controller, thereby controlling the charge current outputted from the pulse width modulation controller. The control switch is turned-on when the comparing voltage is larger than the threshold voltage.

Generally, the threshold voltage generator is a resistor voltage divider.

Preferably the control switch is a transistor.

Certainly, the system current detecting feedback circuit can further include a compensating capacitor electrically connected between an input and an output of the operating amplifier for smoothing the variation of the charge current outputted from the pulse width modulation controller.

According to a further aspect of the present invention, a charge circuit adapted to be used in a portable electronic device for charging a rechargeable battery mounted in the portable electronic device, the portable electronic device being electrically connected to an adapter and power-supplied by the adapter. The charge circuit includes a pulse width modulation controller electrically connected to the rechargeable battery for controlling a charge current to be delivered to the rechargeable battery, and a system current detecting feedback circuit electrically connected between the adapter and the pulse width modulation controller for outputting a control signal to the pulse width modulation controller in response to the comparison between a total current outputted from the adapter and a threshold value, thereby controlling the charge current outputted from the pulse width modulation controller.

It is another object of the present invention to provide a charging method for information system which can high efficiently charge rechargeable battery at low cost.

The present invention may best be understood through the following descriptions with reference to the accompanying drawings, in which:

### BRIEF DESCRIPTION OF THE DRAWING

FIG. 1 is a diagram showing a rechargeable current versus the charge modes of a constant current and a constant voltage according to the prior art;

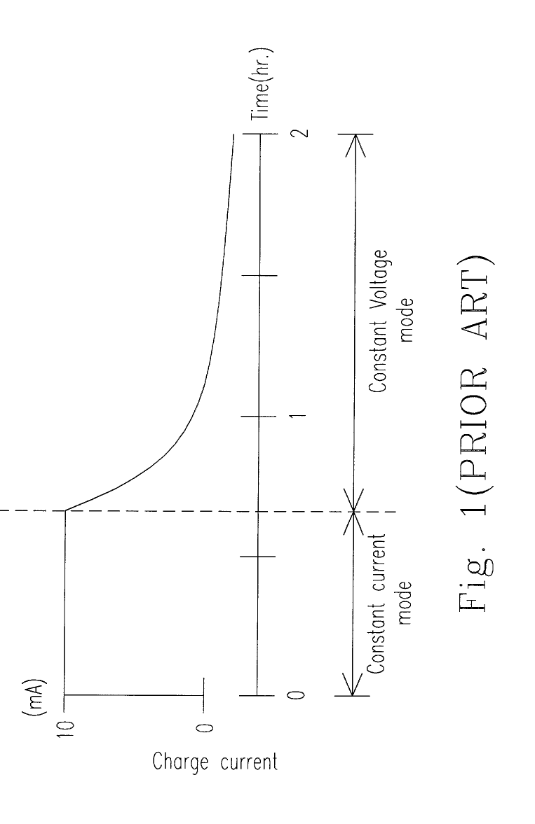

FIG. 2 is a circuit block diagram showing a charge circuit according to a preferred embodiment of the present invention; and

FIG. 3 is a circuit diagram showing a system current detecting feedback circuit according to a preferred embodiment of the present invention.

### DETAILED DESCRIPTION OF THE PREFERRED EMBODIMENTS

The present invention will now be described more detailedly with reference to the following embodiment. It is to be noted that the following descriptions of the preferred embodiments of this invention are presented herein for the purpose of illustration and description only. It is not intended to be exhaustive or to be limited to the precise from disclosed.

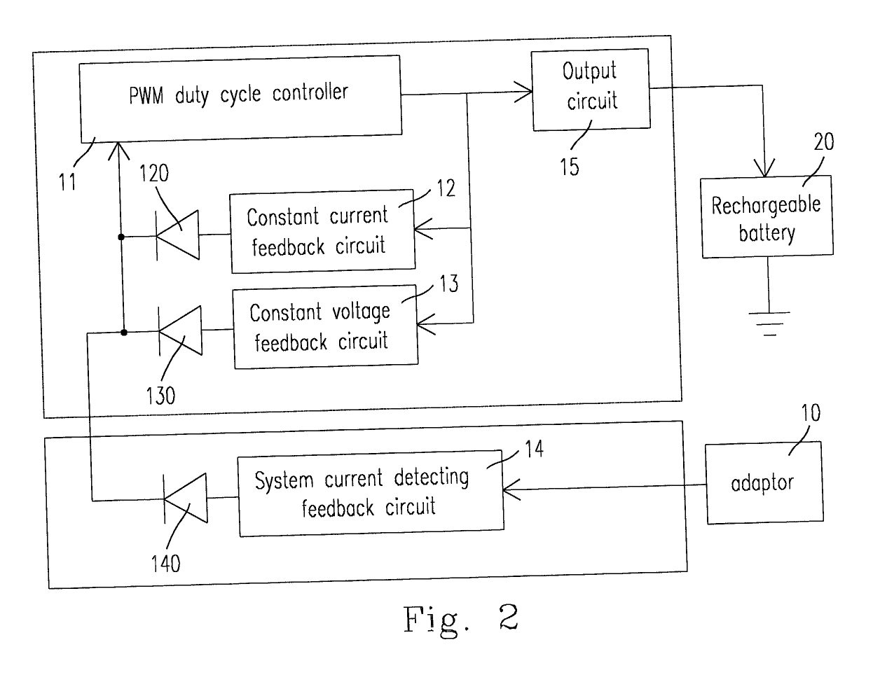

Referring now to FIG. 2, there is shown a charge circuit according to a preferred embodiment of the present invention. The present application discloses a charge circuit adapted to be used in a portable electrical device which needs the charge circuit, such as a portable computer, for charging a rechargeable battery therein. An adapter 10 is electrically connected to the portable electrical device and provides a power-supply.

In the preferred embodiment, the charge circuit mainly includes a pulse width modulation (PWM) duty cycle controller 11, a constant current feedback circuit 12, a constant voltage feedback circuit 13, a system current detecting feedback circuit 14 and a output circuit 15. The PWM duty cycle controller 11 is used for controlling the output circuit 15 to output a charge current to the rechargeable battery 20 by using a pulse width modulation method. The constant current feedback circuit 12 and the constant voltage feedback circuit 13 output a constant current feedback signal and a constant voltage feedback signal, respectively, to the PWM duty cycle controller 11 in response to the magnitude of the charge current and voltage from the PWM duty cycle controller 11, thereby steadying the charge current and voltage outputted from the PWM duty cycle controller 11. Moreover, the charge circuit further includes three diodes 140, 120, 130 electrically connected between the system current detecting feedback circuit 14 and the PWM duty cycle controller 11, the constant current feedback circuit 12 and the PWM duty cycle controller 11, and the constant voltage feedback circuit 13 and the PWM duty cycle controller 11 respectively. The main function of three diodes is to enable to output the largest voltage among the control signal, the constant current feedback signal and the constant voltage feedback signal to be delivered to the PWM duty cycle controller 11.

However, the main function of the system detecting feedback circuit 14 is to output a control signal to the PWM duty cycle controller 11 in response to a result of the comparison between a total current outputted from the adapter 10 and a threshold current. When the total current outputted from the adapter 10 is larger than the threshold current, the charge current outputted from the PWM duty cycle controller 11 to decreased via the control signal.

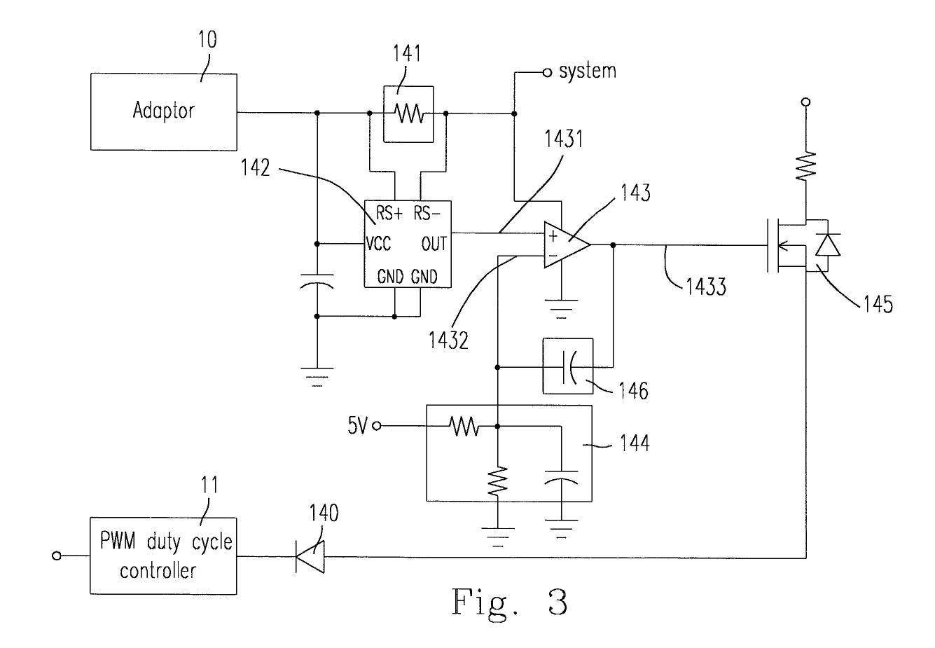

Please refer to FIG. 3, there is shown an architecture of a system detecting feedback circuit 14 according to the present invention. A detecting resistor 141 generates a sense voltage in response to the current outputted from the adapter 10. The sense voltage is amplified via the voltage amplifier 142 to be a comparing voltage which is delivered into a first input 1431 of an operating amplifier 143. A threshold voltage generated by a threshold voltage generator 144 principally composed of a resistor voltage divider is delivered into a second input 1432 of the operating amplifier 143. Therefore, when the total current outputted from the adapter 10 is increased owing to the increasing system load, the sense voltage generated in the detecting resistor 141 increases therewith. In this condition, the comparing voltage outputted from the voltage amplifier 142 is usually lager than the predetermined threshold voltage of the threshold voltage generator 144. Thus, the comparing signal outputted from the output 1433 of the operating amplifier 143 will change from a low level voltage to a high level voltage, and a control switch 145 implemented by a transistor begins to turn-on. Furthermore, a control signal is delivered via the control switch 145 into the PWM duty cycle controller 11 for further controlling the PWM duty cycle controller 11 to output a smaller charge current.

On the contrary, when the total current outputted from the adapter 10 is decreased owing to the diminishing system load, the sense voltage generated from the detecting resistor 141 decreases therewith. In such the situation, the comparing voltage outputted from the voltage amplifier 142 is lower than the predetermined threshold voltage of the threshold voltage generator 144. For this reason, the comparing signal outputted from the output 1433 of the operating amplifier 143 changes from a high level voltage to a low level voltage. Further, the control switch 145 begins to turn-off at this time for controlling the PWM duty cycle controller 11 to amplify the charge current outputted from the PWM duty cycle controller 11. In addition, a compensation capacitor 146 is electrically connected between the second input 1432 and the output 1433 of the operating amplifier 143 in order to smooth the charge current outputted from the PWM duty cycle controller 11, and further to eliminate the audio noise from the charge circuit.

In the above description, the charge circuit according to the present invention is suitable to regulate the magnitude of the charge current outputted from the PWM duty cycle controller 11 in response to the magnitude of the system load. Therefore, the maximum rated charge current provided by the adapter could be utilized efficiently, and the drawback of long charging time can be avoided. Furthermore, although the circuit components applied to the present invention are very common and cheap, the product value is very high.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A charge circuit adapted to be used in an information system for charging a battery mounted in said information system, said information system being electrically coupled to an power source, comprising:
a pulse width modulation controller electrically coupled to said battery for controlling a charge current to be delivered to said battery; and
a system current detecting feedback circuit electrically coupled to said power source and to said pulse width modulation controller for outputting a control signal to said pulse width modulation controller in response to the comparison between a power current outputted from said power source and a threshold value.

2. The charge circuit according to claim 1, further comprising:
a current feedback circuit electrically connected to said pulse width modulation controller for outputting a current feedback signal to said pulse width modulation controller in response to the magnitude of said charge current outputted from said pulse width modulation controller; and
a voltage feedback circuit electrically connected to said pulse width modulation controller for outputting a voltage feedback signal to said pulse width modulation controller in response to the magnitude of a charge voltage outputted from said pulse width modulation controller.

3. The charge circuit according to claim 2, wherein said current feedback circuit is a constant current feedback circuit.

4. The charge circuit according to claim 2, wherein said voltage feedback circuit is a constant voltage feedback circuit.

5. The charge circuit according to claim 2, further comprising three diodes electrically connected between said system current detecting feedback circuit and said pulse width modulation controller, said current feedback circuit and said pulse width modulation controller, said voltage feedback circuit and said pulse width modulation controller, respectively.

6. The charge circuit according to claim 1, wherein said system current detecting feedback circuit comprises:
a detecting component electrically coupled to said power source for generating a sense voltage in response to said power current outputted from said power source;
a voltage amplifier electrically coupled to said detecting component for amplifying said sense voltage to be a comparing voltage;
a threshold voltage generator generating a threshold voltage;
an operating amplifier electrically coupled to said voltage amplifier and said threshold voltage generator for outputting a comparing signal in response to the comparison between said comparing voltage and said threshold voltage; and
a control switch electrically coupled to an output of said operating amplifier and said pulse width modulation controller for allowing said control signal to be fed back to said pulse width modulation controller.

7. The charge circuit according to claim 6, wherein said detecting component is a resistor.

8. The charge circuit according to claim 6, wherein said threshold voltage generator is made of a voltage divider.

9. The charge circuit according to claim 1, wherein said power source is an adapter.

10. The charge circuit according to claim 6, wherein said control switch is a transistor.

11. The charge circuit according to claim 6, further comprising a compensation capacitor electrically coupled between an input and an output of said operating amplifier for smoothing the variation of said charge current outputted from said pulse width modulation controller.

12. A charge circuit adapted to be used in a portable electronic device for charging a battery mounted in said portable electronic device, said portable electronic device being electrically coupled to an power source comprising:
a pulse width modulation controller electrically coupled to said rechargeable battery for controlling a charge current to be delivered to said battery; and
a system current detecting feedback circuit electrically coupled to said power source and to said pulse width modulation controller for outputting a control signal to said pulse width modulation controller in response to the comparison between a power current outputted from said power source and a threshold value.

13. The charge circuit according to claim 12, further comprising:
a current feedback circuit electrically connected to said pulse width modulation controller for outputting a current feedback signal to said pulse width modulation controller in response to the magnitude of said charge current outputted from said pulse width modulation controller; and
a voltage feedback circuit electrically connected to said pulse width modulation controller for outputting a voltage feedback signal to said pulse width modulation controller in response to the magnitude of a charge voltage outputted from said pulse width modulation controller.

14. A charging method for an information system comprising:
outputting a current feedback signal and a voltage feedback signal to a pulse width modulation controller;
outputting a control signal in response to a comparison between a current from a power source and a threshold current to said pulse width modulation controller;
outputting a maximum signal selected from said current feedback signal, said voltage feedback signal and said control signal; and
controlling a charging current by means of said maximum signal outputting.
